(19) United States
(12) Patent Application Publication
(10) Pub. No.: US 2023/0114644 A1
(43) Pub. Date: Apr. 13, 2023

(54) HIGH SPEED DATA COMPRESSION METHODS AND SYSTEMS

(71) Applicant: Digimarc Corporation, Beaverton, OR (US)

(72) Inventor: Hossein Aghakhani, Sugar Land, TX (US)

(21) Appl. No.: 17/497,473

(22) Filed: Oct. 8, 2021

(51) Int. Cl. H04N 19/127; H04N 19/46; H04N 5/232; H04N 19/97; H04N 19/426

(52) U.S. Cl. CPC H04N 19/127; H04N 19/46; H04N 5/23229; H04N 19/97; H04N 19/426

(57) ABSTRACT

In one aspect, a method of fast data compression operates on input data comprising plural J-bit bytes (e.g., 16-bit bytes). The method computes a first difference value between one pair of the input J-bit bytes, and determines that this first difference value can be represented by K bits, where K<J. The method further computes a second difference value between a second pair of the input J-bit bytes, and determines that this second difference value can be represented by M bits, where M<K. These K- and M-bit difference values are included in a composite output data string that also includes four data tags. One tag indicates the first difference value is represented by K bits. Another indicates the second difference value is represented by M bits. The final two tags indicate the polarities of the first and second difference values. A great variety of other features and arrangements are also detailed.

### INTRODUCTION

High speed image collection generates large volumes of data that can choke conventional data channels. A particular example is a camera system that captures imagery of residential waste traveling on a high-speed conveyor belt, for recognition of recyclable items. One such system employs an array of six cameras, each capturing 300 frames per second of 16-bit imagery, at a resolution of 1280×1024 pixels. (Additional details on such arrangements are found in patent publications US20190306385, WO2020186234, and US20210299706. Each of the cameras generates about 6.3 gigabits of raw image data every second.

The referenced recycling system manages this data flow by dividing it up for analysis among dozens of threads of multiple hardware processors. The data finally resulting from the image analysis is of low bandwidth—simply indicating the locations on the belt of different items, and their respective identified plastic compositions.

For research and testing purposes it is desirable to log some or all of the captured imagery in a local or cloud archive. Yet the throughput of conventional data channels is an obstacle. Common disk storage interfaces, and most non-optical network connections, cannot handle such a large data rate. Some form of data compression is required.

Apart from bandwidth issues, compression also saves on storage requirements and costs.

It is desirable that compression be performed using a single thread of a single hardware processor, so that most processing threads can be allocated for image analysis. Thus, the compression method should be fast and light enough not to introduce a burdensome processing task.

Various data compression techniques are known, both lossless and lossy. In lossless compression, the original data can be perfectly reconstructed from the compressed counterpart. In lossy compression, only an approximation of the original data can be reconstructed from the compressed counterpart. In our application, lossless compression is required.

LZ77 and LZ78 are two familiar types of lossless data compression and respectively refer to methods taught by Lempel and Ziv in their 1977 and 1978 papers. Both are dictionary coders. A dictionary coder is a class of techniques that operates by searching for matches between the input data to be compressed and a set of strings contained in a data structure (the “dictionary”) maintained by the encoder. When the encoder finds such a match, it substitutes a reference to the string's position in the data structure.

In LZ77, a circular buffer called the “sliding window” holds the last N bits of data processed. This window serves as the dictionary, effectively storing every substring that has appeared in the past N bits as dictionary entries. Instead of a single index identifying a dictionary entry, two values are needed: the length, indicating the length of the matched text, and the offset (also called the distance), indicating where the match is found in the sliding window.

LZ78 uses a more explicit dictionary structure, which is compiled during use. Data found in the dictionary is represented in the output string simply by an index identifying the dictionary entry.

(Additional details are found in the original Lempel/Ziv papers: “A Universal Algorithm for Sequential Data Compression,” IEEE Transactions on Information Theory, 1977, Vol. 23, No. 3, pp. 337-343; and “Compression of Individual Sequences via Variable-Rate Coding,” IEEE Transactions on Information Theory, 1978, Vol. 24, No. 5, pp. 530-536.)

These and other dictionary coder techniques offer good compression, but the need to search the dictionary for a string that matches an input data string slows them down, preventing real-time operation with high data rates, especially if only a single processing thread is used. Moreover, these algorithms generally do not exploit particular characteristics of the input data which can offer opportunities for higher compression rate and speed.

Thus, there is a need for a system that can compress high volumes of imagery quickly and simply.

Certain aspects of the present technology address such needs. A variety of other features and advantages are also detailed.

### BRIEF DESCRIPTION OF THE DRAWINGS

FIG. 1 shows elements of an illustrative recycling system in which aspects of the present technology can be employed.

FIG. 1A shows a variation on the FIG. 1 system.

FIG. 2 shows an illustrative image to be compressed, depicting a plastic object on a dark conveyor belt.

FIG. 3A shows an array of sample 16-bit pixel values.

FIG. 3B shows an array of pixel-difference values derived from the pixel array of FIG. 3A.

FIG. 4 is a coding table indicating different field length tags that denote different pixel-difference bit field lengths.

FIG. 5 shows pixel value differences, field lengths, binary difference values, field length tags, value difference polarities, polarity tags, and resulting bit strings, associated with the first six pixel values in the array of FIG. 3A.

FIG. 6 shows how data elements from the FIG. 5 table, for each of the FIG. 3A pixels, are arrayed in a composite binary data string.

FIG. 7 is a flow chart detailing a particular compression method incorporating certain aspects of the present technology.

### DETAILED DESCRIPTION

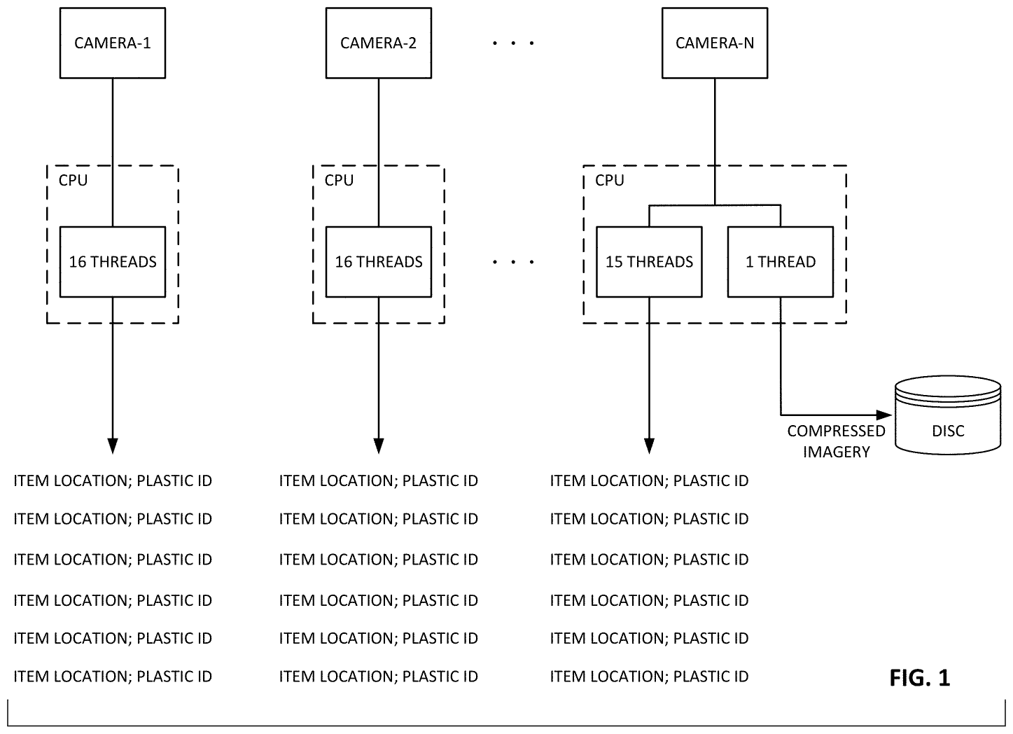

FIG. 1 shows elements of an illustrative recycling system in which aspects of the present technology can be employed. Multiple cameras (e.g., model HB-1800-S-M cameras by Emergent Vision Technologies) capture 300 frames per second of imagery (each), depicting a conveyor belt carrying waste items. Each frame is of size 1280×1024 pixels, and each pixel is represented by 16 bits. Each camera provides imagery to an associated multi-core CPU, such as an Intel 9960X CPU. Most of the CPU threads are used for image analysis. (One thread may be a dispatcher process that allocates analysis tasks to the other threads.) A primary output of the image analysis is data indicating belt locations at which items are detected, and an indication of the plastic type of each recognized item.

One of the cameras, shown on the right, applies one of its execution threads to compression of the imagery captured by that camera. The compressed data is then stored on disk (or transmitted over a network connection).

While imagery from just one camera is compressed in the example of FIG. 1, in other embodiments the imagery from others (or all) of the cameras can be similarly compressed, using a thread in the CPU associated with that camera.

FIG. 1A shows a variant embodiment, in which imagery from all of the cameras is transmitted to an array of processors, such as five of the just-noted Intel 9960X CPUs. Again, most of the execution threads are used for image analysis. A single thread serves to compress the imagery from the cameras, and send it for disk storage.

The disk storage used in FIGS. 1 and 1A can be a physical hard disk drive, or a solid state drive. In the embodiment of FIG. 1, the disk drive may employ a SATA-2 or USB 3.0 interface. SATA-2 has a peak bandwidth of 3 Gbits/second. USB 3.0 has a peak bandwidth of 5 GBits/second. As noted earlier, a single camera in the exemplary embodiment has a raw data output of about 6 Gbits/second. Thus, such interfaces cannot transfer the camera imagery at the required rates without compression. And the compression must be fast enough to output data at the same frame rate as the input data is provided (i.e., real-time operation). Desirably the compression operation should not require more than a single thread to execute.

In the embodiment of FIG. 1A, the data rate is six times that of FIG. 1, i.e., 38 Gbit/second. The latest USB 3 revision (USB 3.2 SuperSpeed+) offers data transfer rates of up to 20 Gbit/second, but even the rare storage systems that can operate at this rate cannot manage the 38 Gbit/second produced by the six cameras of FIG. 1A. Again, real-time compression is required, desirably with minimal computational resources.

The fast compression needed in these systems can be achieved by the arrangements detailed below.

In an exemplary system, the exposure interval for each captured image is very short—typically under 100 microseconds. Supplemental lighting must be used to assure adequate illumination of items on the conveyor belt. Even so, the resulting images tend to be dark, and vacant regions of the dark conveyor belt (which comprise more than 50% of most images) are nearly black, and are thus represented by pixels of low (dark) values. Moreover, in the majority of the images there is not any object; the image depicts only a dark conveyor belt.

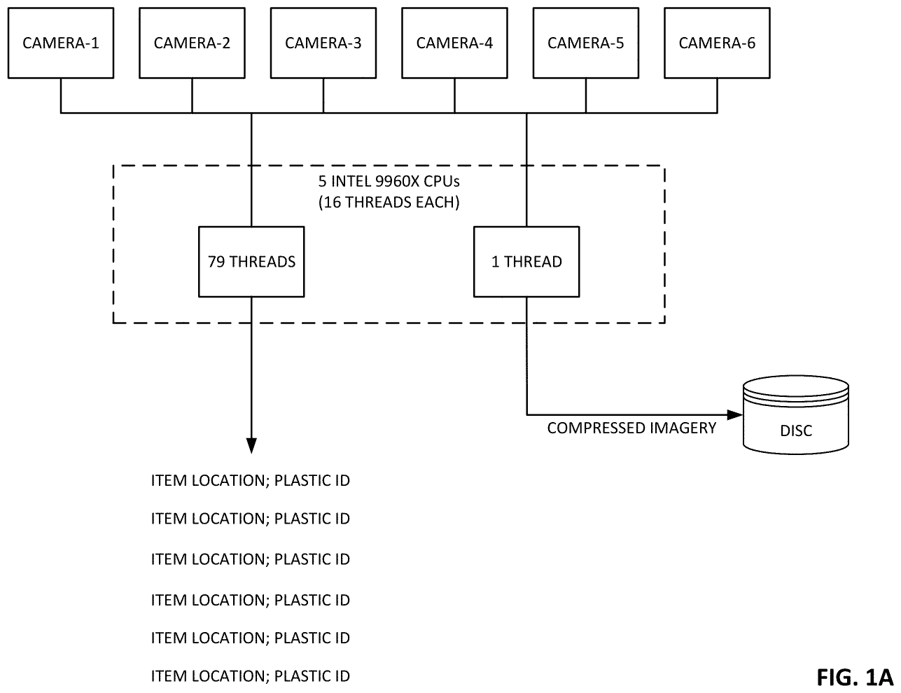

FIG. 2 shows a sample image of plastic waste, of the sort that may be compressed using embodiments of the present technology. As noted, most of the images depict nothing but the dark conveyor belt.

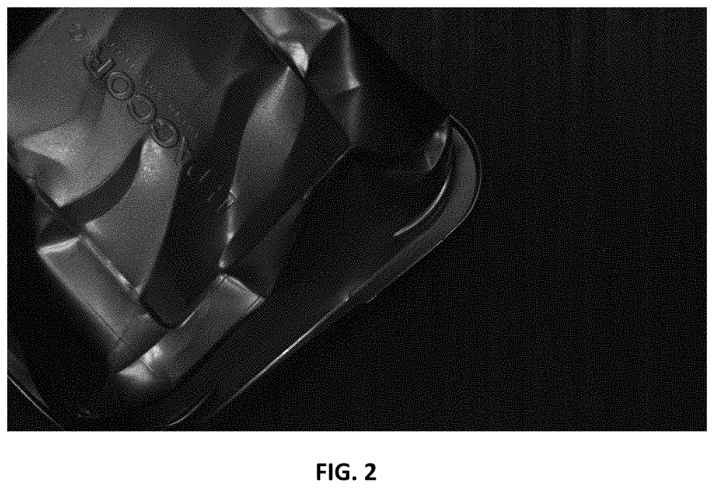

FIG. 3A shows an array of 16-bit pixel values (e.g., depicting a hypothetical 5×3 pixel image frame). The 16-bit representation allows pixel values to range from decimal 0 to 65,535 (i.e., from binary 0000000000000000 to 1111111111111111). The detailed pixels are all at the low end of this range (i.e., dark), as is common.

In an illustrative embodiment, a difference array—corresponding to the pixel array—is computed. That is, a difference is computed between pairs of neighboring pixel values. (The neighbors are typically adjoining pixels, but this is not strictly necessary.) FIG. 3B shows a difference array corresponding to FIG. 3A.

The first value in FIG. 3B, the “1648” in the upper left, is the difference between the first image pixel value from FIG. 3A and its neighboring predecessor. Since there is no predecessor, we use a value of 0, yielding 1648 as the first difference value.

The second value in FIG. 3B, “−64,” is the first pixel value (1648) subtracted from the second pixel value (1584). The third value in FIG. 3B, “0,” is the second pixel value (1584) subtracted from the third pixel value (1584). The fourth value in FIG. 3B, “1,” is the third pixel value (1584) subtracted from the fourth pixel value (1585). This process continues through the image, continuing from the right edge of one row to the left edge of the next row below, through to the last pixel in the lower right of the image. Due to correlation of neighboring pixels in natural imagery, the values in the difference frame of FIG. 3B are generally smaller than the values in the original pixel frame of FIG. 3A.

Small difference values require fewer bits to represent than large difference values. In the illustrative embodiment, fields of different bit lengths (e.g., of 2-, 4-, 8-, 12- or 16-bits) are used to represent the difference values, with the shortest field that can represent each difference value being used in each instance.

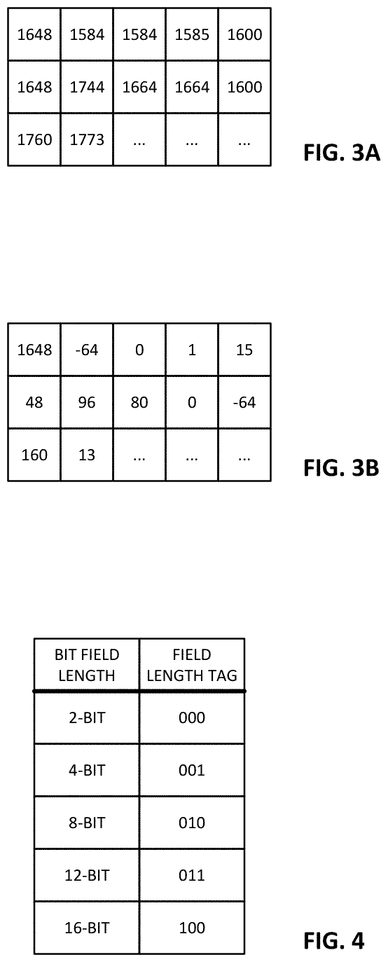

To permit a decoder to correctly interpret these different-length fields, so that it can thereby reconstruct the original array of pixel data, a field length tag is associated with each difference value. Field length tags of three bits are used in the illustrative embodiment, but longer or shorter tags can naturally be used, depending on the particular application. As shown in FIG. 4, a field length tag of “100” indicates that a difference value is represented as a 16-bit field. A field length tag of “011” indicates that a difference value is represented as a 12-bit field. And so on, with a field length tag of “000” indicating that a difference value is represented as a 2-bit field.

In the exemplary embodiment, the absolute value of each difference is represented by the variable length (2-bit to 16-bit) field. The sign of the difference is represented by a separate single-bit flag, with “1” indicating a positive difference value, and “0” indicating a negative difference value. (A difference value of zero can use either bit flag.)

Thus, three data are associated with each value in the difference frame of FIG. 3B (and thus with each pixel in the image frame of FIG. 3A). One datum is a 3-bit field length tag. Another datum is the difference value itself—zero-padded as necessary to fill-out the 2-, 4- 8-, 12- or 16-bit field. And the last datum is a one-bit flag indicating the sign of the difference value.

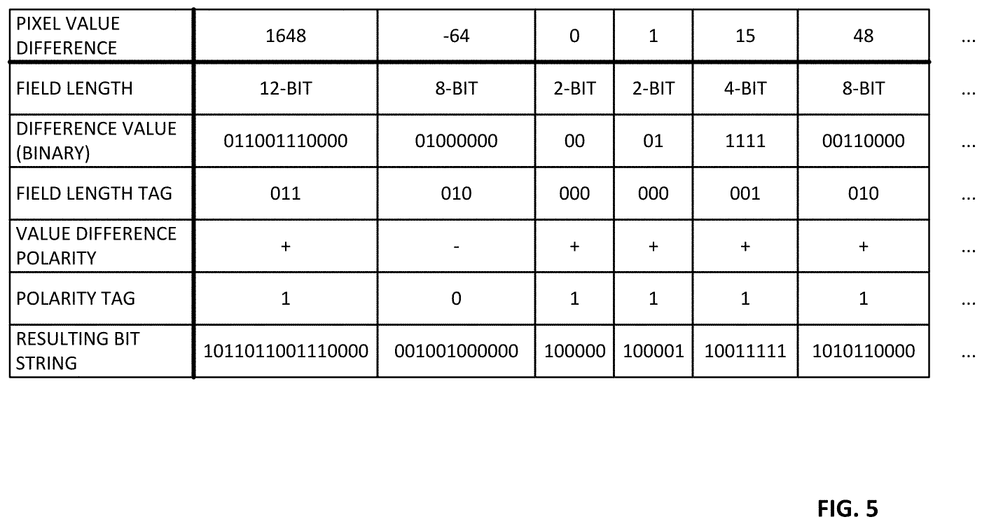

FIG. 5 details these data for several of the difference values in FIG. 3B. As shown in this figure, the first difference value of 1648 can be represented in a 12-bit field. (A 12-bit field is used to represent values up to (2\hat{ }12)−1, which can't be represented by the next-smaller, 8-bit, field. 12-bit fields are thus used for difference values in the range 256−4095.) The difference value 1648 represented as a 12-bit number is 011001110000.

The field length tag “011” is used to signal that this difference value is represented as a string of 12 bits.

The difference 1648 is a positive number, so the polarity bit flag is a “1.”

These three data can be conveyed in any order. In the bottom row of the FIG. 5 table the data are ordered as polarity bit flag (“1”) first, followed by the field length tag (“011”), followed by the difference value expressed as 12-bit binary (“011001110000”), yielding the string “1011011001110000.”

It will be recognized that this just-mentioned string is 16 bits in length. The image pixel was originally-represented as a 16-bit datum, so there is no economy in this form of representation, in this instance. But in other instances, a savings is achieved.

The next column of FIG. 5, for instance, shows the coding of the difference value “−64.” As shown by the bottom cell in this column of the table, this difference value is represented by the string “001001000000,” which comprises 12 bits. This effects a 4-bit shortening of the original 16-bit pixel value.

The next two columns show savings of even more bits. Each represents a difference value by 6 bits, as contrasted with the 16-bits required for the original pixels. Ten bits are saved for each pixel.

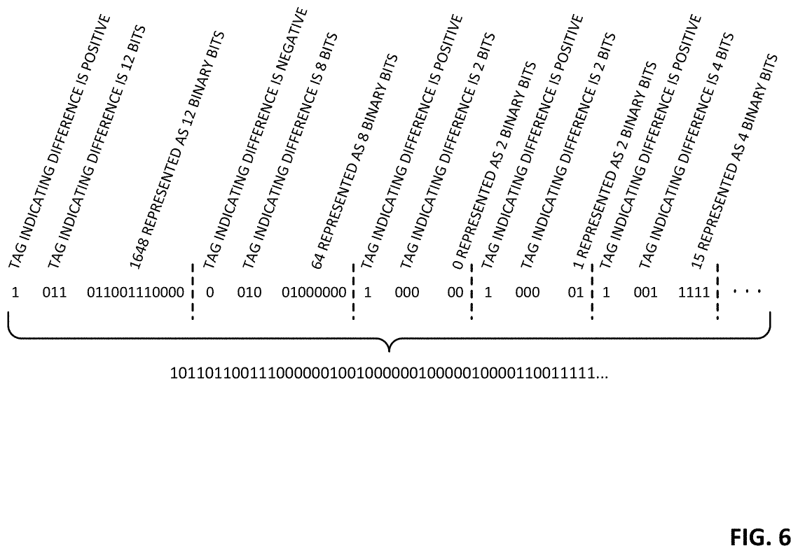

FIG. 6 shows that a single composite string can be assembled from the data elements detailed in FIG. 5. There are 48 digits in the composite string at the bottom of FIG. 6. These data correspond to five 16-bit image pixels, which originally required 80 digits to express.

The string at the bottom of FIG. 6 may be regarded as a once-compressed counterpart to the input image data. However, the field length tags and the zero-padding of the difference values, introduce sub-strings that occur with more than random probabilities in the composite string. Such redundancies offer further opportunities for compression—opportunities that dictionary-based coding methods are suited to exploit.

Thus, in certain embodiments the above-detailed compression arrangement is followed by second phase of compression, such as an implementation of LZ77 or LZ78 compression. In an illustrative embodiment, Zstandard software is used. Zstandard software (sometimes abbreviated Zstd) was developed at Facebook and is based on LZ77 principles. An open source reference implementation of the code is available from the Facebook site on the Github service (Facebook<dot>github<dot>io/zstd/). The output data from this second phase of data compression can be regarded as a twice-compressed counterpart to the input data. This twice-compressed data is then stored on a disk drive device, or transmitted on a network (e.g., for cloud storage or analysis).

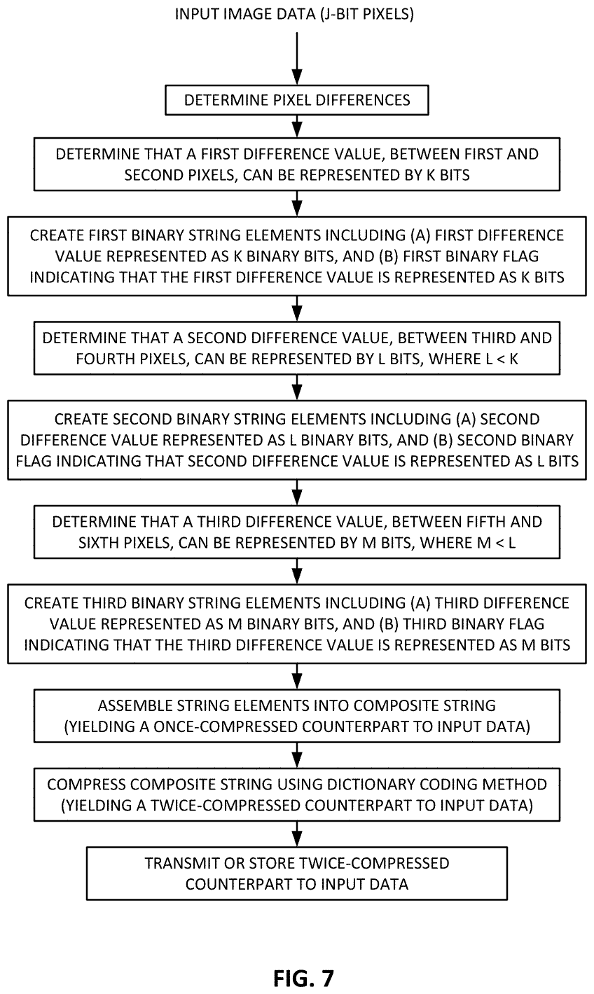

FIG. 7 is a flowchart detailing aspects of the above-described compression method.

Recovery of the original data from the compressed data is straight-forward. If the compressed data is of the twice-compressed form, a decompression algorithm corresponding to the second phase of compression is applied. An advantage of Zstandard is that it can be trained for the data to increase the compression ratio and speed. This feature is helpful when the library is used to compress many similar data that mostly have similar patterns, as ii our case here. The open source implementation of Zstandard software includes fast decompression code. Zstandard decompression yields the once-compressed counterpart to the input data, e.g., as depicted by the composite string at the bottom of FIG. 6.

This composite string can be parsed serially. The first bit (“1”) indicates that the polarity of the first difference value is positive. The next three bits (“011”) indicate that the following difference value is represented as a 12-bit string. The decompressor takes the following 12-bits, and zero-pads them to yield a 16-bit number, which is the pixel value of the first pixel (1648).

The decompressor continues by examining the next bit in the composite string (“0”), which indicates that the polarity of the second difference value is negative. The following three bits (“010”) indicate that the following difference value is represented as an 8-bit string. The decompressor then takes the next 8-bits, and subtracts them from the just-determined value of the preceding pixel (because the polarity of the difference is negative), yielding the pixel value of the second pixel (1584).

The decompressor then examines the next bit in the composite string (“1”), which indicates that the polarity of the third difference value is positive. The following three bits (“000”) indicate that the following difference value is represented as a 2-bit string. The decompressor than takes the next 2-bits, and adds them to the just-determined value of the preceding pixel (because the polarity of the difference is positive), yielding the pixel value of the third pixel (1584).

The decompressor continues in this fashion until it has worked its way through the composite bit string and re-created the original array of pixel values shown in FIG. 3A.

It will be recognized that the compression method detailed above is exceedingly fast and simple, and is suited to single-thread execution. No string-matching is required. The second phase of compression, when used, is slower. But it operates on data that has already been compressed once, so the throughput requirements for the second phase of compression are not as demanding as requirements for the first phase.

### CONCLUDING REMARKS

Having described and illustrated aspects of the technology with reference to illustrative embodiments, it will be recognized that the technology is not so-limited.

For example, while the input data in the exemplary arrangements is natural image data, this is not required. The technology can be used with data of any sort, including audio and video data, synthetic image data, data from other sensors, and data resulting from other data processing operations.

Similarly, while the exemplary arrangements concern lossless compression, this is not required. In a different embodiment the input data can be quantized, losing one or more least significant bits of resolution. Such quantized data, with the LSB(s) truncated, can be compressed using the above-described arrangements, yielding fast and simple compression, but without the ability to recover the finest level of resolution.

While the difference data in the detailed embodiment is determined between the present pixel and the immediately-preceding pixel, this too is not required. The difference data can be relative to any other known pixel value in the input data set, such as one or two pixels away from the current pixel—either forwards or backwards.

Moreover, in some embodiments the difference may be relative to a spatially-corresponding pixel (i.e., at the same row/column coordinates) in a preceding image frame. Or where, as in the illustrative system, a camera captures imagery from a belt that advances by generally consistent spatial offsets between successive frames (e.g., 72 rows of pixels in a particular example), the difference can be between a pixel in the current frame and a pixel in the same column, but 72 rows away, in the previous frame.

Still further, the difference may be between the current pixel value, and an average of two or more other pixels. These other pixels may all be in the current image row, or may be from plural rows.

The use of five different bit field lengths in the detailed arrangement is exemplary and not limiting. Other arrangements can use more or fewer different bit field lengths. With the three-bit field length tag of the detailed embodiment, eight different bit field lengths can be represented (e.g., 2-, 4-, 6-, 8-, 10-, 12-, 14- and 16-bit fields).

Although the detailed embodiment was described as a pixel-by-pixel process in which a pixel value is input, and compressed data corresponding to that pixel is immediately output, this is not necessary. In some embodiments an entire frame of pixel values is buffered, and is then processed. In such an arrangement all of the difference values are computed. All of the polarities are then known. All of needed field lengths are determined, together with associated field length tags. Only after all of this data is generated are any of the output data elements, i.e., the triplet of: polarity tags, field length tags, or difference values, output.

In one such embodiment these data elements are not output as successive triplets, e.g., {polarity tag, field length tag, difference value, polarity tag, field length tag, difference value . . . }. Instead, the like elements are all grouped together. For example, the output data string may start with polarity tags for all 1,310,720 pixels in the frame, followed by field length tags for all the pixels in the frame, followed by the difference values for all the pixels in the frame. Or variant data packing can be used, such as pairing the polarity tag and field length tag for each pixel into a 4-bit string, and sending such strings for all 1,310,720 pixels in the frame grouped together, followed by the difference values for all the pixels in the frame, etc. In a further variant, the difference values are grouped based on their field lengths. For example, all of the 2-bit differences can be grouped together, followed by all of the 4-bit differences, etc. (The order with which such differences should be used during decompression is indicated by the order in which the field length tags are presented.)

In another embodiment that buffers and then processes an image frame, the difference value for a pixel need not involve, solely, pixels that are earlier in a row/column scan down the image frame. For example, the difference value for a pixel can be relative to the average of the eight surrounding pixels, i.e., those that are vertically-, horizontally-, and diagonally-adjoining. In this case decompression is less straight-forward and slower, since determination of each pixel value requires solving systems of multiple variables. (The values of the four corner pixels and other of pixels scattered through the image frame can be left uncompressed as known constraints for this process.) But in many applications it is acceptable for the decompression process to be slower than the compression process. (This particular arrangement can also result in a small degree of data loss, since the averaging process can yield non-integer values.)

Although the technology is described in the context of a recycling system, it will be recognized that large volumes of data must be compressed quickly in many other contexts. One example is astronomy. Another is medical imaging. Another is particle detection in high energy physics. Etc.

The imagery in the detailed examples is assumed to be greyscale. Color imagery (e.g., RGB or CMYK) can be compressed similarly, with each color channel compressed separately.

Although not detailed earlier, it will be understood that the compressed output data is accompanied by certain overhead, or administrative data. This data can precede the compressed output data in a header data structure. This data structure can include, e.g., data identifying the image frame, data specifying the frame dimensions in rows/columns, data specifying the bit depth of the pixels (e.g., 16-bit), etc. It can further include error checking data, such as a CRC value. It may also include a count of the number of pixels represented as 2-bit differences, the number of pixels represented by 4-bit differences, etc.

In some embodiments the high bandwidth input (image) data is first stored on a high-speed disk drive (e.g., a solid state drive equipped USB 3.2 SuperSpeed+interface), and this data is thereafter read from high-speed drive and compressed using the detailed technology before storage on longer-term, slower-speed storage media, or transmission over the internet (e.g., to cloud storage).

As indicated, the processes and system components detailed in this specification can be implemented as instructions for computing devices, including general purpose processor instructions for a CPU such as the cited Intel 9960X processor. Implementation can also employ a variety of specialized processors, such as graphics processing units (GPUs, such as are included in the nVidia Tegra series, and the Adreno 530—part of the Qualcomm Snapdragon processor), and digital signal processors (e.g., the Texas Instruments TMS320 and OMAP series devices, and the ultra-low power Qualcomm Hexagon devices, such as the QDSP6V5A), etc. The instructions can be implemented as software, firmware, etc. These instructions can also be implemented in various forms of processor circuitry, including programmable logic devices, field programmable gate arrays (e.g., the Xilinx Virtex series devices), field programmable object arrays, and application specific circuits—including digital, analog and mixed analog/digital circuitry. Although single-threaded execution of the instructions is preferred, execution can be distributed among processors and/or made parallel across processors within a system or across a network of devices. Processing of data can also be distributed among different processor and memory devices. References to “processors,” “modules” or “components” should be understood to refer to functionality, rather than requiring a particular form of implementation.

Implementation can additionally, or alternatively, employ special purpose electronic circuitry that has been custom-designed and manufactured to perform some or all of the component acts, as an application specific integrated circuit (ASIC).

Software instructions for implementing the detailed functionality can be authored by artisans without undue experimentation from the descriptions provided herein, e.g., written in C, C++, etc., in conjunction with associated data.

Software and hardware configuration data/instructions are commonly stored as instructions in one or more data structures conveyed by tangible media, such as magnetic or optical discs, semiconductor memory, etc., which may be accessed across a network.

Although disclosed as a complete system, sub-combinations of the detailed arrangements are also separately contemplated (e.g., omitting various of the features of a complete system).

While aspects of the technology have been described by reference to illustrative methods, it will be recognized that apparatuses configured to perform the acts of such methods are also contemplated as part of applicant's inventive work. Likewise, other aspects have been described by reference to illustrative apparatus, and the methodology performed by such apparatus is likewise within the scope of the present technology. Still further, tangible computer readable media containing instructions for configuring a processor or other programmable system to perform such methods is also expressly contemplated.

To provide a comprehensive disclosure, while complying with the Patent Act's requirement of conciseness, applicant incorporates-by-reference each of the documents referenced herein. (Such materials are incorporated in their entireties, even if cited above in connection with specific of their teachings.) These references disclose technologies and teachings that applicant intends be incorporated into the arrangements detailed herein, and into which the technologies and teachings presently-detailed be incorporated.

In view of the wide variety of embodiments to which the principles and features discussed above can be applied, it should be apparent that the detailed embodiments are illustrative only, and should not be taken as limiting the scope of the invention.

1. A method of fast data compression including the acts:
receiving input data comprising plural J-bit bytes, each having a respective J-bit value;
determining a first difference value between a first of said received J-bit bytes and a second J-bit value;
determining that said first difference value can be represented by K bits;
including in a composite binary string: (a) said first difference value, represented as K binary bits, and (b) a first binary flag indicating that the first binary string conveys a difference value expressed as K binary bits;
determining a second difference value between a third of said received J-bit bytes and a fourth J-bit value;
determining that said second difference value can be represented by L bits; and
including in said composite binary string: (a) said second difference value represented as L binary bits, and (b) a second binary flag indicating that the second binary string conveys a difference value expressed as L binary bits;
wherein:
said composite binary string defines a once-compressed counterpart of said input data;
the second binary flag is different than the first binary flag; and
L<K.

2. The method of claim 1 that further includes:
compressing the composite string by a lossless compression process, thereby defining a twice-compressed counterpart of the input data; and
transmitting or storing said twice-compressed counterpart of the input data.

3. The method of claim 2 that includes losslessly-compressing the composite string with a dictionary coding method.

4. The method of claim 1 performed by a single thread of a multi-thread processing system.

5. The method of claim 1 using a single thread of a multi-thread processing system to process more than 5 gigabits of input data per second.

6. The method of claim 1 using a single thread of a multi-thread processing system to process more than 20 gigabits of input data per second.

7. The method of claim 1 in which the composite binary string includes a first flag bit indicating a polarity of the first difference value and a second flag bit indicating a polarity of the second difference value.

8. The method of claim 1 in which the second J-bit value is a second of said received J-bit bytes, and said fourth J-bit value is a fourth of said received J-bit bytes.

9. The method of claim 8 in which the first and second received J-bit bytes are pixel values that are adjacent in a row or column of image data.

10. The method of claim 8 that further includes:
determining a third difference value between a fifth of said received J-bit bytes and a sixth of said received J-bit bytes;
determining that said third difference value can be represented by M bits; and
including in said composite binary string: (a) said third difference value represented as M binary bits, and (b) a third binary flag indicating that the third binary string conveys a difference value expressed as M binary bits;
wherein the third binary flag is different from the first and second binary flags, and M<L<K.

11. The method of claim 10 that further includes:
determining a fourth difference value between a seventh of said received J-bit bytes and an eighth of said received J-bit bytes;
determining that said fourth difference value can be represented by N bits; and
including in said composite binary string: (a) said fourth difference value represented as N binary bits, and (b) a fourth binary flag indicating that the fourth binary string conveys a difference value expressed as N binary bits;
wherein the fourth binary flag is different from the first, second and third binary flags, and N<M<L<K.

12. The method of claim 11 in which J=16, K=12, L=8, M=4, and N=2.

13. The method of claim 11 that further includes:
determining a fifth difference value between a ninth of said received J-bit bytes and a tenth of said received J-bit bytes;
determining that said fifth difference value can be represented by P bits; and
including in said composite binary string: (a) said fifth difference value represented as P binary bits, and (b) a fifth binary flag indicating that the fifth binary string conveys a difference value expressed as P binary bits;
wherein the fifth binary flag is different from the first, second, third and fourth binary flags, and P<N<M<L<K.

14. The method of claim 13 in which J=16, K=16, L=12, M=8, N=4, and P=2.

15. The method of claim 8 in which K=J.

16. The method of claim 8 in which J=16.

17. A data compression apparatus including one or more processors and associated memory, the memory including software instructions that configure the one or more processors to perform acts including:
receiving input data comprising plural J-bit bytes, each having a respective J-bit value;
determining a first difference value between a first of said received J-bit bytes and a second J-bit value;
determining that said first difference value can be represented by K bits;
including in a composite binary string: (a) said first difference value, represented as K binary bits, and (b) a first binary flag indicating that the first binary string conveys a difference value expressed as K binary bits;
determining a second difference value between a third of said received J-bit bytes and a fourth J-bit value;
determining that said second difference value can be represented by L bits; and
including in said composite binary string: (a) said second difference value represented as L binary bits, and (b) a second binary flag indicating that the second binary string conveys a difference value expressed as L binary bits;
wherein the second binary flag is different than the first binary flag, and L<K.

18. The apparatus of claim 17 that further includes a conveyor belt and a camera positioned to capture imagery depicting items on the conveyor belt, said camera being coupled to the one or more processors to provide said J-bit bytes of input data thereto.

19. The apparatus of claim 17 that further includes a camera positioned to capture astronomical imagery depicting astronomical bodies against a dark background, said camera being coupled to the one or more processors to provide said J-bit bytes of input data thereto.

20. (canceled)

21. A method including the acts:
receiving a composite binary data string;
identifying from the composite binary data string a field length tag indicating that a first difference value conveyed in the composite binary data string is expressed as K binary bits; and
summing said first difference value with a first base value, and storing the resultant sum as a J-bit byte in an output data array;
wherein K<J.

22-27. (canceled)
